(19) United States
(12) Patent Application Publication
(10) Pub. No.: US 2016/0183515 A1
(43) Pub. Date: Jun. 30, 2016

(54) ANIMAL BAIT WITH POST ENGAGEMENT SHAPE

(71) Applicant: Rick SCHMIDT, Crofton, MD (US)

(72) Inventor: Rick SCHMIDT, Crofton, MD (US)

(21) Appl. No.: 14/587,586

(22) Filed: Dec. 31, 2014

(51) Int. Cl. A01M 31/00; A01M 31/06

(52) U.S. Cl. CPC A01M 31/008; A01M 31/06

(57) ABSTRACT

A bait for attracting animals and configured for positioning around a substantially vertical member is provided. The bait includes a body portion having a substantially centrally located substantially vertical opening that extends through the entire body portion, the opening being configured for positioning around the substantially vertical member such that the substantially vertical member extends completely though the opening. The body portion is a food for the animals.

### BACKGROUND OF THE INVENTION

1. Field of the Disclosed Embodiments

The disclosed embodiments relate to attracting animals.

2. Introduction

Many people attract wild animals for observation, food, sport, or other reasons. As an aid in pursuing these and other interests, baits are sometimes used to attract the animals. Many types of baits are available including liquid scents, salt blocks, pelletized food, and other attractants. These baits have disadvantages that, in most, if not all, cases, include quick dissipation and a lack of ability to stand up to weather. Many baits also have the disadvantage that they can be carried away by the very animals which the bait is designed to attract, or other animals.

As a result, there is a need for a bait that resists degradation from weather and is not quickly consumed or carried off by animals.

### SUMMARY

Particular embodiments of the invention are directed to a bait for attracting animals and configured for positioning around a post, tree trunk, or other shaft. The bait includes a hole, for example a vertical hole, through the bait. The bait can be lowered over a post, tree truck, or other shaft such that the post, tree trunk, or shaft extends through the hole. Particular exemplary embodiments provide a substantially cylindrical, doughnut-shaped bait with the hole being centrally located and extending vertically through the entire bait.

Particular embodiments of the invention are directed to a bait for attracting animals and configured for positioning around a substantially vertical member. The bait includes a body portion having a substantially centrally located substantially vertical opening that extends through the entire body portion, the opening being configured for positioning around the substantially vertical member such that the substantially vertical member extends completely though the opening, wherein the body portion is a food for the animals.

Other embodiments of the invention are directed to a bait/container combination, the bait being for attracting animals and configured for positioning around a substantially vertical member, the combination includes a container and a bait. The container has a bucket portion having a substantially flat bottom, a truncated cone shaped side portion, and an opening; and a removable top that seals the opening of the bucket portion. The bait has a body portion having a substantially centrally located substantially vertical body opening that extends through the entire body portion, the body opening being configured for positioning around the substantially vertical member such that the substantially vertical member extends completely though the body opening. The body portion is a food for the animals, and an outside shape of the body portion conforms to the side portion of the bucket portion.

Other embodiments of the invention are directed to a method of making a bait for attracting animals, the bait being configured for positioning around a substantially vertical member and having a body portion having a substantially centrally mounted substantially vertical body opening that extends through the entire body portion, the body opening being configured for positioning around the substantially vertical member such that the substantially vertical member protrudes though the body opening, and the body portion is a food for the animals. The method includes placing an opening lining in a container, the container having a side portion; pouring a mixture of the food into the container around the opening lining such that the poured mixture stays between the opening lining and the side portion of the container; and allowing the poured mixture to set into a solid. When the poured mixture is set into a solid, an area inside the opening lining forms the body opening.

### BRIEF DESCRIPTION OF THE DRAWINGS

The following figures form part of the present specification and are included to further demonstrate certain aspects of the disclosed features and functions, and should not be used to limit or define the disclosed features and functions. Consequently, a more complete understanding of the exemplary embodiments and further features and advantages thereof may be acquired by referring to the following description taken in conjunction with the accompanying drawings, wherein:

FIG. 1 is a perspective view of an exemplary embodiment of the invention;

FIG. 2 is a side view of the embodiment shown in FIG. 1, in use;

FIG. 3 is a side view of an exemplary embodiment of the invention;

FIG. 4 is a perspective view of an exemplary embodiment of the invention;

FIG. 5 is a perspective view of an opening lining in accordance with an embodiment of the invention;

FIG. 6 is a perspective view of the opening lining shown in FIG. 5 in place in an exemplary bucket in accordance with an exemplary embodiment of the invention;

FIGS. 7-9 show exemplary embodiments of the invention;

FIG. 10 is a perspective view of an exemplary embodiment of the invention including an opening lining; and

FIG. 11 shows an example of a method in accordance with embodiments of the invention.

### DETAILED DESCRIPTION

The invention is described herein with reference to the accompanying drawings in which exemplary embodiments of the invention are shown. The invention may, however, be embodied in many different forms and should not be construed as limited to the embodiments set forth herein.

Various embodiments of the disclosed embodiments may be discussed in detail below. While specific implementations may be discussed, it should be understood that this may be done for illustration purposes only. A person skilled in the relevant art may recognize after reviewing this disclosure that other components and configurations may be used without parting from the spirit and scope of the disclosed embodiments.

The disclosed embodiments comprise a variety of embodiments, such as a method and apparatus and other embodiments that relate to the basic concepts of the disclosed embodiments.

As explained above, the problem with many available baits is that they are quickly consumed by the animals or are easily carried off by the animals. Both of these problems result in fewer return visits by the animals to the location at which the bait was originally set.

To address these problems, the invention provides a bait that is positioned over some sort of vertical pole in order to prevent the bait from being carried away by animals. An example of such a vertical pole is a small dead tree that is cut off a distance, for example five feet, above the ground. Other examples are a typical nominal 4″×4″ post or a piece of reinforcing steel driven into the ground. Also, the bait stands up well to weather because the composition of the bait is somewhat water resistant.

The drawings show some exemplary embodiments of the invention.

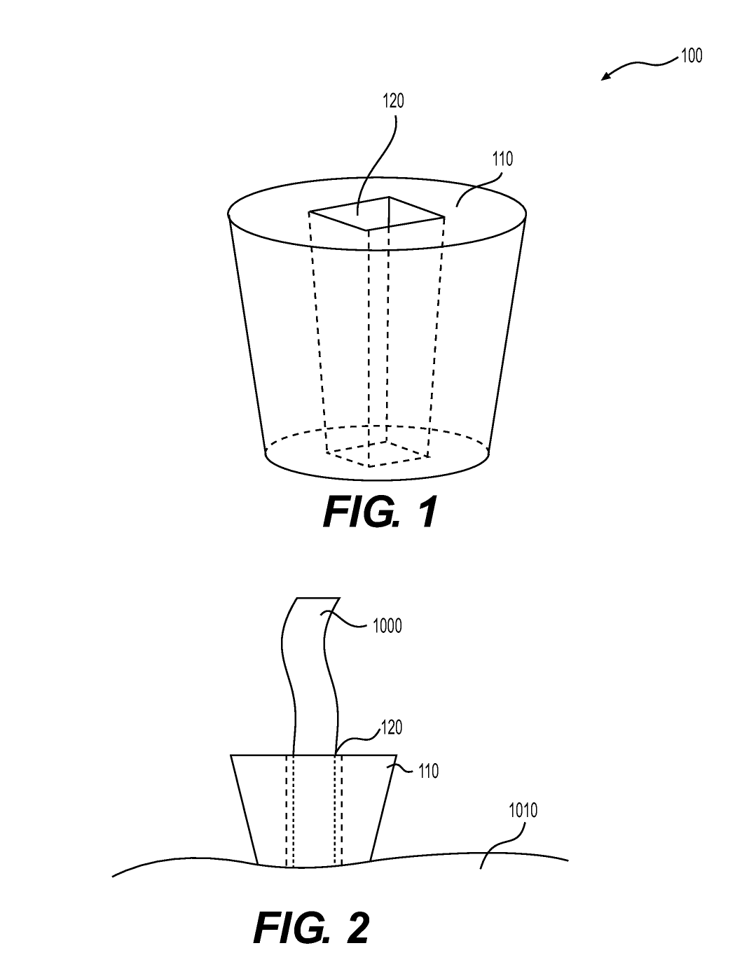

FIG. 1 shows an example of a bait 100 in accordance with the invention. Bait 100 has a body portion 110 and an opening 120. Opening 120 extends vertically completely through body portion 110 to provide passage of a vertical pole on which bait 100 is positioned for use.

FIG. 2 is a schematic view of bait 100 positioned around a tree trunk 1000. In this example, tree trunk 1000 results from a dead tree, for example, that has been cut off some distance (for example, five feet) above the ground 1010. Bait 100 is then lowered over tree trunk 1000 such that tree trunk 1000 passes through opening 120 in body portion 110. By positioning bait 100 in this way, animals cannot simply carry bait 100 away.

In the example shown in FIGS. 1 and 2, the entirety of bait 100 is formed in one piece. In particular embodiments, the entirety of bait 100 is formed from a single material. The material from which bait 100 is formed is a material that the target animal considers food and is attracted to. One example of the material is a mixture of corn cornels, sugar, corn syrup, and other natural flavorings. In an exemplary manufacturing process of bait 100, these ingredients are mixed together, heated, poured into a mold, and allowed to set. The bait is then removed from the mold producing a solid structure made entirely of the material. This finished product is strong enough to support its own weight and hold together while pieces are bitten off by animals.

Other examples of materials that can be used are salts, calcium, phosphorous, sodium bicarbonate, other minerals, synthetic urine, natural urine, sugar beet smash, proteins, and glandular materials and their secretions such as tarsal gland, interdigital gland, orbital gland, vaginal secretions, hormones and pheromones. In some embodiments, one or more of these ingredients is included in an amount up to about 30 percent of the total volume with the rest of the total volume being an inert ingredient such as corn cornels or chips, sugar, corn syrup, etc.

In the example of sodium bicarbonate, the sodium bicarbonate can be heated to a temperature of approximately 250 degrees Fahrenheit and poured into a mold.

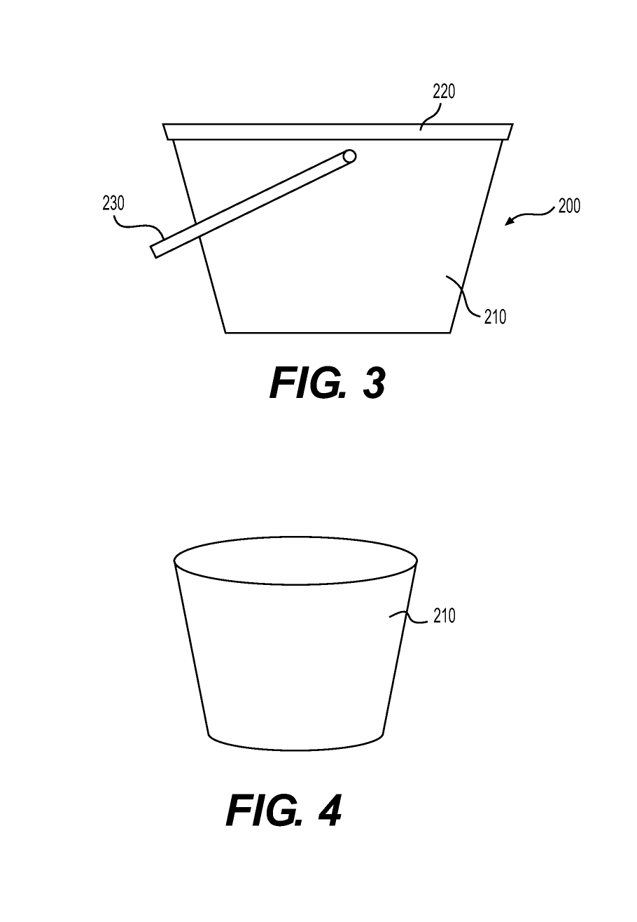

FIG. 3 is a side view of an embodiment that includes a container 200 in which bait 100 is formed. In this example, container 200 includes a bucket portion 210, a top or lid 220, and a handle 230. FIG. 4 shows bucket portion 210 with lid 220 removed. An example of bucket portion 210 is a simple plastic bucket.

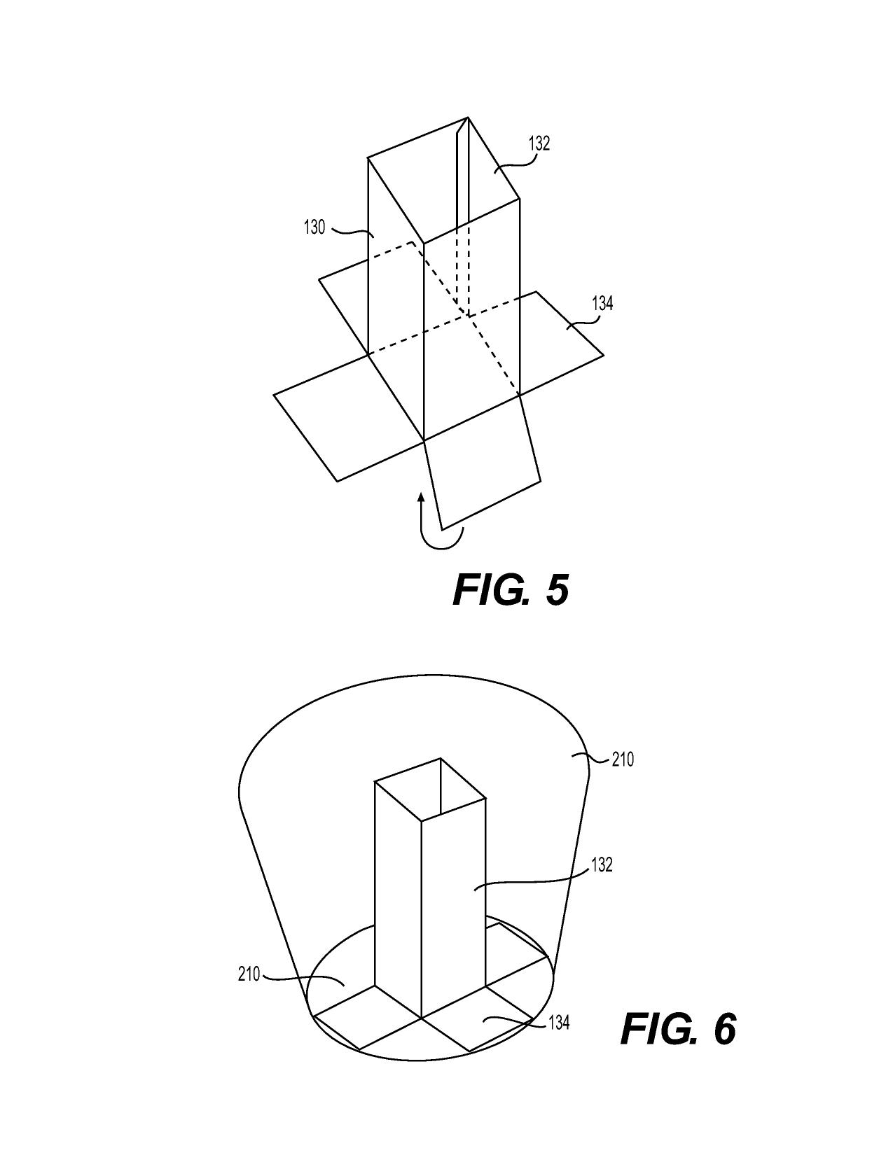

FIG. 5 shows an example of an opening lining 130 that can be used during the molding process of bait 100 to form opening 120. In this example, opening lining 130 has four sides 132 and four corresponding flaps 134. This example of opening lining 130 can be made from a flat sheet of material such as, for example, cardboard, sturdy paper, or other biodegradable, animal safe material.

FIG. 6 shows opening lining 130 positioned in bucket portion 210 (the wall of bucket portion 210 is cut away for clarity) ready to receive the material from which body portion 110 of bait 100 is formed. In some embodiments, one flap 134 is folded under the central opening of opening lining 130 to help prevent the material from entering the central opening. In this and other embodiments, the remaining three (or in other embodiments, all four) flaps 134 can be used as a gage to centrally locate opening lining 130 in bucket portion 210. With opening lining 130 in place, the material (for example molten corn cornels, sugar and corn syrup) is poured into bucket portion 210 and around opening lining 130. Opening lining 130 substantially, if not completely, contains the material and thus forms opening 120. Opening lining 130 is, in some embodiments, a part of the finished bait 100 (see FIG. 10). In other embodiments, opening lining 130 is removed from bait 100 before use.

In some embodiments, bucket portion 210 is sprayed with a release agent before the molten material is poured into bucket portion 210. After the material has set, bucket portion 210 can simply be inverted and bait 100 removed from bucket portion 210.

After the molten material is poured into bucket portion 210, top 220 can be attached to bucket portion 210 for transport.

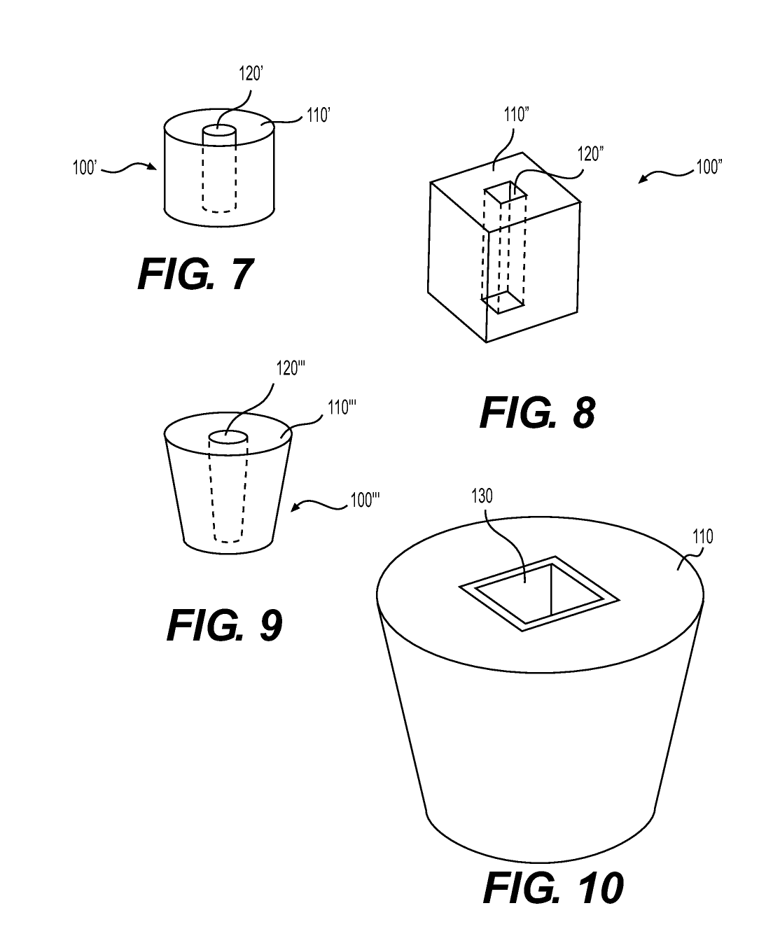

FIGS. 7-9 show a few alternate embodiments of the invention. FIG. 7 shows a bait 100′ having a body portion 110′ that is round with a circular opening 120′. FIG. 8 shows a bait 100″ having a body portion 110″ that is square with a square opening 120″. FIG. 9 shows a bait 100′ having a body portion 110′ that is a truncated cone with a circular opening 120′. These are just a few examples of alternate configurations of the invention.

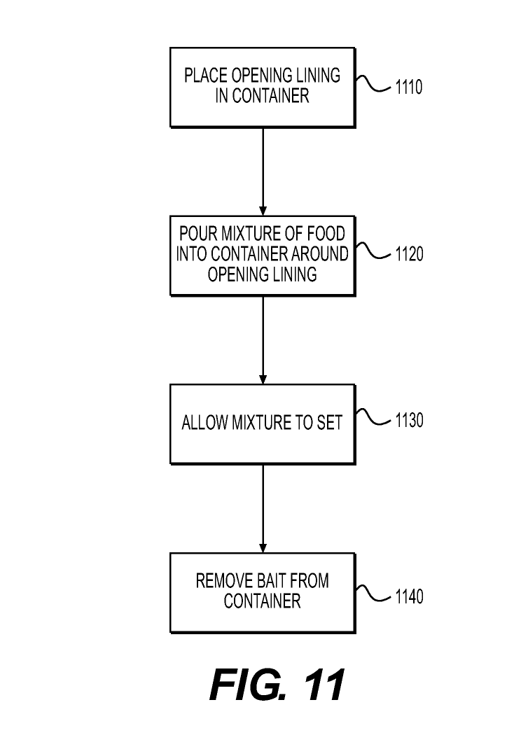

FIG. 11 shows an example of a method in accordance with embodiments of the invention. In 1110, the opening lining is placed in the container. In 1120, the mixture of food is poured into the container and around the opening lining. In 1130, the mixture is allowed to set. And in 1140, the bait is removed from the container.

It is noted that the proportions and relative sizes of the elements of the examples shown in the figures are exemplary only and are not limiting. Different sizes and proportions of the elements can be used as long as bait 100 is strong enough and shaped properly to allow installation over a shaft of some sort. One example of bait 100 has an upper diameter of approximately 10-12 inches, a lower diameter of approximately 10-12 inches, an outside shape of a truncated cone, a height of approximately 8-10 inches, and an opening that is approximately 4 inches by 4 inches. These dimensions represent just one example of a possible embodiment of the invention.

Although the above description may contain specific details, they should not be construed as limiting the claims in any way. Other configurations of the described examples of the disclosed embodiments may be part of the scope of the disclosed embodiments. Specific configurations of particular elements of an exemplary embodiment can be interchanged with other embodiments and still be within the scope and spirit of the invention.

What is claimed is:

1. A bait for attracting animals and configured for positioning around a substantially vertical member, the bait comprising:
a body portion having a substantially centrally located substantially vertical opening that extends through the entire body portion, the opening being configured for positioning around the substantially vertical member such that the substantially vertical member extends completely though the opening,
wherein the body portion is a food for the animals.

2. The bait of claim 1, wherein the body portion is made of a single material, the single material being the food for the animals.

3. The bait of claim 2, wherein the body portion is made entirely of only the single material.

4. The bait of claim 3, further comprising an opening lining located directly adjacent the body portion and defining the opening.

5. The bait of claim 4, wherein the opening lining is cardboard or paper.

6. The bait of claim 4, wherein the opening has a square cross section along a horizontal plane.

7. The bait of claim 6, wherein the body portion has an outside shape, and the outside shape is a truncated cone.

8. The bait of claim 3, wherein the opening has a square cross section along a horizontal plane.

9. The bait of claim 3, wherein the body portion has an outside shape, and the outside shape is a truncated cone.

10. A bait/container combination, the bait being for attracting animals and configured for positioning around a substantially vertical member, the combination comprising:
a container having
a bucket portion having a substantially flat bottom, a truncated cone shaped side portion, and an opening; and
a removable top that seals the opening of the bucket portion; and
a bait having a body portion having a substantially centrally located substantially vertical body opening that extends through the entire body portion, the body opening being configured for positioning around the substantially vertical member such that the substantially vertical member extends completely though the body opening,
wherein the body portion is a food for the animals, and
an outside shape of the body portion conforms to the side portion of the bucket portion.

11. The combination of claim 10, wherein the body portion is made of a single material, the single material being the food for the animals.

12. The combination of claim 11, wherein the body portion is made entirely of only the single material.

13. The combination of claim 12, further comprising an opening lining located directly adjacent the body portion and defining the body opening.

14. The combination of claim 13, wherein the opening lining is cardboard or paper.

15. The combination of claim 13, wherein the body opening has a square cross section along a horizontal plane.

16. The combination of claim 15, wherein the outside shape of the body portion is a truncated cone.

17. The combination of claim 12, wherein the body opening has a square cross section along a horizontal plane.

18. The combination of claim 12, wherein the outside shape of the body portion is a truncated cone.

19. A method of making a bait for attracting animals, the bait being configured for positioning around a substantially vertical member and having a body portion having a substantially centrally mounted substantially vertical body opening that extends through the entire body portion, the body opening being configured for positioning around the substantially vertical member such that the substantially vertical member protrudes though the body opening, and the body portion is a food for the animals, the method comprising:
placing an opening lining in a container, the container having a side portion;
pouring a mixture of the food into the container around the opening lining such that the poured mixture stays between the opening lining and the side portion of the container; and
allowing the poured mixture to set into a solid,
wherein when the poured mixture is set into a solid, an area inside the opening lining forms the body opening.

20. The method of claim 19, wherein the side portion of the container is shaped as a truncated cone.
